(19) United States
(12) Patent Application Publication
(10) Pub. No.: US 2024/0402005 A1
(43) Pub. Date: Dec. 5, 2024

(54) Solar Irradiance Sensor with Diffuse Isolator

(71) Applicants: Michael Gostein, Austin, TX (US); Josh Horst, Austin, TX (US); Stan Faullin, Round Rock, TX (US)

(72) Inventors: Michael Gostein, Austin, TX (US); Josh Horst, Austin, TX (US); Stan Faullin, Round Rock, TX (US)

(21) Appl. No.: 18/653,937

(22) Filed: May 2, 2024

Related U.S. Application Data
(60) Provisional application No. 63/470,499, filed on Jun. 2, 2023.

(51) Int. Cl. G01J 1/42; G01J 1/04

(52) U.S. Cl. CPC G01J 1/42; G01J 1/0474; G01J 2001/4266

(57) ABSTRACT

In one respect, disclosed is a device comprising an irradiance sensor and a diffuse isolator covering said irradiance sensor, wherein said diffuse isolator comprises a housing, baffles, aperture openings, and a window, and wherein said diffuse isolator is configured to block direct rays emanating from the sun, and wherein said diffuse isolator is configured to admit diffuse rays emanating from a region of the sky dome, and wherein said device is configured to measure diffuse solar irradiance at least from readings of said irradiance sensor. In another respect, disclosed is a device also comprising at least one additional irradiance sensor configured to view at least a substantial portion of the sky dome, and wherein said device is configured to measure diffuse solar irradiance at least from readings of said irradiance sensor and said at least one additional irradiance sensor.

### CROSS-REFERENCE TO RELATED APPLICATIONS

This application claims the benefit of U.S. Provisional Patent Application 63/470,499, filed Jun. 2, 2023, which is hereby incorporated by reference.

### STATEMENT OF GOVERNMENT INTEREST

The disclosed invention was made with Government support under DE-SC0020831 from the Department of Energy. The Government has certain rights in this invention.

### FIELD OF THE INVENTION

The disclosed subject matter is directed to the measurement of solar irradiance.

### SUMMARY

In one respect, disclosed is a device comprising an irradiance sensor and a diffuse isolator covering said irradiance sensor, wherein said diffuse isolator comprises a housing, baffles, aperture openings, and a window, and wherein said diffuse isolator is configured to block direct rays emanating from the sun, and wherein said diffuse isolator is configured to admit diffuse rays emanating from a region of the sky dome, and wherein said device is configured to measure diffuse solar irradiance at least from readings of said irradiance sensor. In another respect, disclosed is a device also comprising at least one additional irradiance sensor configured to view at least a substantial portion of the sky dome, and wherein said device is configured to measure diffuse solar irradiance at least from readings of said irradiance sensor and said at least one additional irradiance sensor.

### BRIEF DESCRIPTION OF THE DRAWINGS

FIG. 1 depicts various components of solar radiation reaching a surface.

FIG. 2 depicts an embodiment of a device according to the present disclosure and illustrates how direct rays (102) from the sun (10) are blocked by diffuse isolator (220) while diffuse rays (104) from a region of the sky dome (14) are transmitted to irradiance sensor (202).

FIG. 3 depicts an embodiment of a device according to the present disclosure.

FIG. 4 depicts an exploded view of the embodiment of FIG. 2.

FIG. 5 depicts a cross-sectional view of the embodiment of FIG. 2.

### DETAILED DESCRIPTION OF THE INVENTION

Measurements of sunlight intensity, or solar irradiance, are important to the field of solar energy generation for purposes of both predicting and monitoring the performance of solar energy installations.

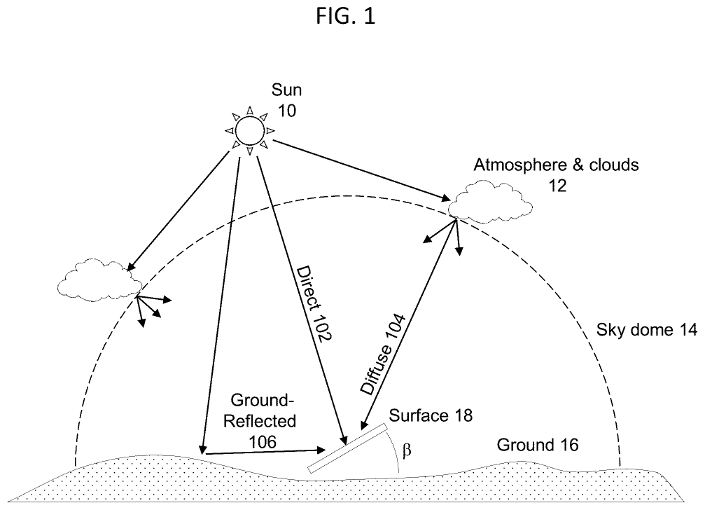

As depicted in FIG. 1, the solar radiation striking a surface (18) may consist of multiple components, including: direct irradiance (102), comprising rays emanating directly from the sun (10); diffuse irradiance (104), comprising rays that are scattered by the atmosphere or clouds (12) prior to striking the surface (18); and ground-reflected irradiance (106), comprising rays that scatter or reflect from the ground (16) prior to striking the surface (18). Note that FIG. 1 is not to scale and all rays emanating directly from the sun are nearly parallel at the earth.

In some embodiments direct irradiance (102) is quantified in terms of the radiation crossing a plane normal to rays emanating from the sun (10) and this is denoted as Direct Normal Irradiance (DNI). Other measures may also be used. Direct irradiance (102) may also be denoted as beam irradiance.

In some embodiments diffuse irradiance (104) is regarded as emanating equally from the entire sky dome (14), i.e. isotropically. In other embodiments, diffuse irradiance (104) is regarded as having multiple components emanating from different portions of the sky dome (14). Such different components may include diffuse irradiance (104) emanating from the circumsolar disc (an angular region immediately around the sun (10)), diffuse irradiance (104) emanating from the horizon, and diffuse irradiance (104) emanating from the remainder of the sky dome (14), as well as other possible components. In some embodiments diffuse irradiance (104) is quantified as the sum of all diffuse irradiance (104) components reaching the top of a horizontal plane surface and this sum is denoted as Diffuse Horizontal Irradiance (DHI); in some embodiments various components of this sum are treated separately. Other measures may also be used.

In some embodiments ground-reflected irradiance (106) may be quantified as the total reflected irradiance, generally diffuse, emanating upwards from the ground (16) and measured in a downward-facing horizontal plane, and may be denoted Ground-Reflected Irradiance (GRI) or Reflected Horizontal Irradiance (RHI). In some embodiments ground-reflected irradiance (106) is quantified in terms of albedo p, the ground-surface reflectivity or the ratio of upwelling ground-reflected irradiance (RHI) to downwelling irradiance (GHI). Other measures may also be used.

Irradiance reaching a surface (18) from 180 degrees field of view is denoted as global irradiance. Special cases include Global Horizontal Irradiance (GHI) for a horizontal surface (18) and Global Tilted Irradiance (GTI) for a tilted surface (18). Global irradiance at any surface (18) may have components of direct (102), diffuse (104), and ground-reflected (106) irradiance, and may be related to DNI, DHI, and RHI.

For some applications it is desirable to measure or otherwise determine individual components of solar irradiance, such as direct (102), diffuse (104), or ground-reflected (106) irradiance.

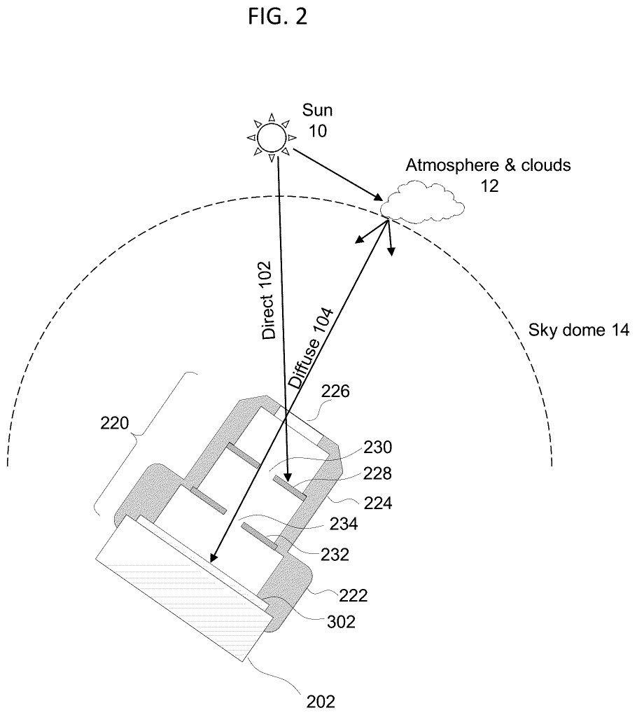

FIG. 2 depicts an embodiment of a device according to the disclosed subject matter for measuring diffuse (104) irradiance. In the embodiment depicted, the device comprises an irradiance sensor (202) and a diffuse isolator (220). In one embodiment the irradiance sensor (202) is a photovoltaic (PV) reference cell comprising a glass-covered encapsulated PV cell (302). The diffuse isolator (220) is placed over the irradiance sensor (202). The diffuse isolator (220) comprises a lower housing (222) which makes a light-tight seal with irradiance sensor (202); an upper housing (224) which in some embodiments has a tubular shape; a window (226) for admitting light; a first baffle (228) with a first aperture opening (230); and optionally a second baffle (232) with a second aperture opening (234). The interior of the diffuse isolator (220) assembly is made to be non-reflective, for example by black anodizing or by painting with a non-reflective paint. In some embodiments the entire assembly comprising the irradiance sensor (202) and diffuse isolator (220) is tilted away from the equator (i.e., in the northern hemisphere, to the north); in an exemplary embodiment, the tilt angle is 35 degrees. Accordingly, direct (102) rays emanating from the sun (10) may enter the diffuse isolator via the window (226) but will be intercepted by the first baffle (228). Any portion of direct (102) rays which reflect or scatter off the interior surfaces of the diffuse isolator (220) and pass through first aperture opening (230) will have a broad angular distribution and therefore only a small portion of these rays will pass through second aperture opening (234). In contrast, diffuse (104) rays emanating from clouds (12) or a portion of the sky dome (14) within the field of view of the diffuse isolator (220) will pass through first aperture opening (230) and second aperture opening (232) and be detected by irradiance sensor (202). Thereby in some embodiments diffuse (104) irradiance from a region of the sky dome (14) within the view of the diffuse isolator (220) is measured.

Note in FIG. 2 that items are not to scale. In reality the radius of the sky dome (14) is much larger than the size of the irradiance sensor (202) and diffuse isolator (220).

In some embodiments irradiance sensor (202) comprises a PV cell. In other embodiments, another type of photodetector is used, for example a photodiode or a thermal sensor such as a pyranometer.

In some embodiments, the number of baffles (228, 232) or windows (226) is greater or lesser than depicted.

In some embodiments at least one aperture opening (230, 234) is replaced by a lens (not shown) configured to increase the transmission through the diffuse isolator (220) of rays entering the window (226) at approximately normal incidence and to decrease the transmission of rays entering the window (226) at larger angles. For example, replacing first aperture opening (230) by a lens which focuses normally-incident rays at second aperture opening (234), rays which enter window (226) near normal incidence are preferentially passed through to irradiance sensor (202) in higher proportion than rays that enter at larger angles. In some embodiments this increases the rejection ratio of direct (102) rays relative to diffuse (104) rays.

In some embodiments the tilt angle and angular orientation of the device is configured to ensure that direct (102) rays from the sun (10) can never strike the window (226) within the acceptance angle defined by the dimensions of the diffuse isolator (220) including the baffles (228, 232) and aperture openings (230, 234) or other optical elements. For example, given that the earth's axis has a declination of approximately 23.5 degrees, the sun can never be more than approximately 23.5 degrees from the zenith position towards the direction away from the equator. Therefore, if the geometry of the diffuse isolator (220) is designed to accept rays within a 10-degree range of the diffuse isolator (220) axis (i.e. rays striking window (226) within 10 degrees of normal) and the diffuse isolator (220) is tilted at least 35 degrees towards the direction away from the equator, direct (102) rays can never penetrate to the irradiance sensor (202). Thereby in some embodiments diffuse (104) rays are measured to the exclusion of direct (102) rays.

In some embodiments diffuse isolator (220) also blocks ground-reflected rays (106).

In some embodiments, the signal of irradiance sensor (202) is calibrated to relate the measured signal of diffuse (104) rays passing through the diffuse isolator (220) to a particular quantity parameterizing diffuse (104) irradiance, such as DHI. In some embodiments, said calibration is linear. In other embodiments, said calibration takes another more complex functional form.

In some embodiments, the signal of irradiance sensor (202) is averaged over a period of time to eliminate the effects of spikes in the signal that may occur as clouds (12) pass in and out of the field of view of the diffuse isolator (220).

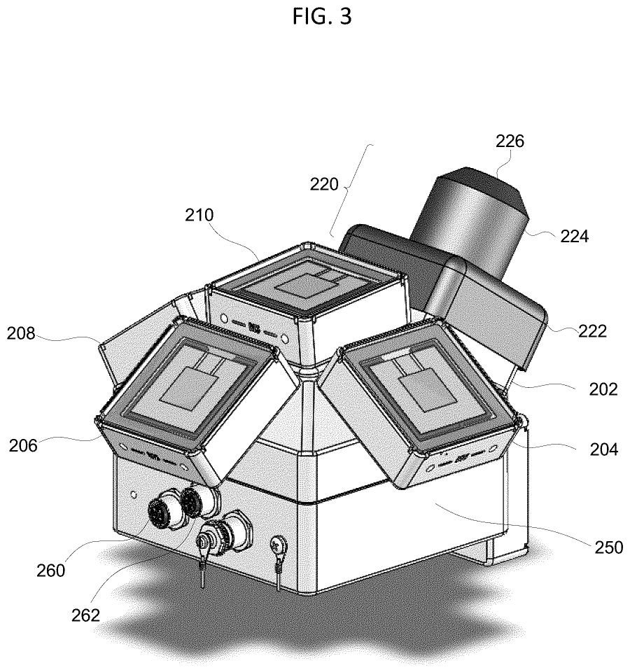

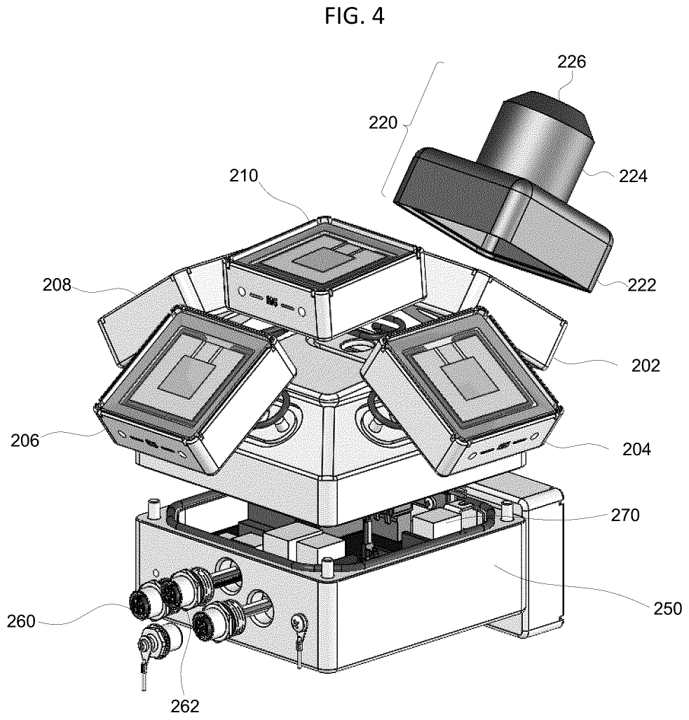

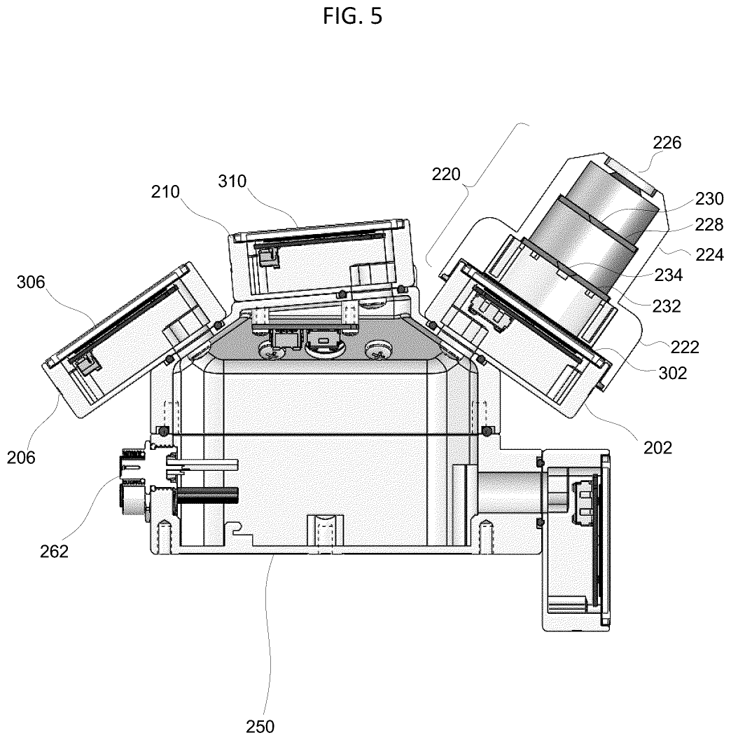

FIG. 3, FIG. 4 and FIG. 5 depict different views of an embodiment comprising irradiance sensor (202) and diffuse isolator (220) together with additional components, wherein FIG. 4 is an exploded view of the embodiment in FIG. 3 and FIG. 5 is a cross-sectional view of the embodiment in FIG. 3.

The embodiment depicted in FIG. 3 comprises four irradiance sensors (202, 204, 206, 208), on an exemplary 35-degree tilt angle, which we denote as “north,” “east,” “south,” and “west” sensors, and a fifth irradiance sensor (210) on an exemplary 5-degree tilt towards the south which we denote as the “center” sensor. The “north” irradiance sensor (202) is covered by diffuse isolator (220). Here we assume placement in the northern hemisphere and “north” should be understood to mean “away from the equator” and would be replaced with “south” if the device were placed in the southern hemisphere. Tilt angles are exemplary and could be replaced with other values. In some embodiments power and communication signals, including data, are transmitted via port (260) and in some embodiments power and/or communication with auxiliary sensor devices (not shown) are transmitted through auxiliary port (262). A housing (250), such as a metal, plastic, or fiberglass enclosure, provides mounting services for the components of the device and encloses additional elements shown in other views, such as the controller board (PCB) (270) depicted in FIG. 4. In some embodiments controller board (270) comprises power and communication circuitry and a processor or computer with memory and configured instructions, receives signals from the irradiance sensors (202, 204, 206, 208, 210), and performs analyses to process data and provide results to a user via port (260), for example over a digital interface with an industry-standard protocol such as MODBUS or any equivalent system. In some embodiments irradiance sensors (202, 204, 206, 208, 210) comprise glass-covered encapsulated PV cells (302, 304, 306, 308, 310) each of which, in some embodiments, also comprise an internal measurement board PCBs which signal processing and/or data acquisition electronics.

The embodiment depicted in FIG. 3, FIG. 4, and FIG. 5, contains a number of components; in various embodiments, any of the components might be omitted, substituted, or duplicated.

In one embodiment the device comprises the north irradiance sensor (202) with diffuse isolator (220) and the center irradiance sensor (210). In some embodiments, diffuse irradiance (104) or DHI is determined by a combination of readings from the north irradiance sensor (202) with diffuse isolator (220) and the center irradiance sensor (210). For example, in one embodiment, the device is configured to estimate GHI from readings of the center irradiance sensor (210) and to calculate a clearness index which is the ratio of the estimated GHI to the GHI expected for clear-sky conditions, which may be calculated from device latitude, longitude, altitude, and time, using methods known in the art. In some embodiments clearness index is alternatively defined. In some embodiments the device is configured such that when clearness index is high (i.e. for cloud-free skies) DHI is estimated by calibrated readings of the north irradiance sensor (202) with diffuse isolator (220), while when clearness index is low (i.e. for cloudy skies) DHI is estimated from readings of center irradiance sensor (210). In some embodiments the device is configured to gradually adjust its output between these two limits as a smooth function of clearness index. In some embodiments, readings of center irradiance sensor (210) are used to generate estimates of DHI by using decomposition models, such as described in M. Lave, W. Hayes, A. Pohl, and C. W. Hansen, “Evaluation of global horizontal irradiance to plane-of-array irradiance models at locations across the United States,” IEEE J. Photovoltaics, vol. 5, no. 2, pp. 597-606, March 2015, doi: 10.1109/JPHOTOV.2015.2392938, which is hereby incorporated by reference. In some embodiments the device is configured to estimate DHI by a combination of readings from north irradiance sensor (202) with diffuse isolator (220) and center irradiance sensor (210) using an alternative model, such as a trained neural network model.

In some embodiments the device comprises a ground-facing irradiance sensor, not depicted in FIG. 3, FIG. 4, or FIG. 5. In some embodiments the ground-facing irradiance sensor is connected via auxiliary port (262).

In some embodiments the device comprises the five sky-facing irradiance sensors (202, 204, 206, 208, 210) at different angular orientations depicted in FIG. 3 and FIG. 4 or any subset of them or a similar combination at various angular orientations, and in some embodiments also comprises a ground-facing irradiance sensor (not shown). In some embodiments the device is configured to process readings of multiple irradiance sensors (e.g. 202, 204, 206, 208, 210 and optionally a ground-facing irradiance sensor) to determine values of DHI, DNI, and/or RHI, for example as described in U.S. Pat. No. 11,650,103, U.S. patent application Ser. No. 17/214,978, or U.S. patent application Ser. No. 17/547,293, each of which is hereby incorporated by reference. In some embodiments north irradiance sensor (202) is included in said analysis, with appropriate modification of calculation owing to the presence of the diffuse isolator (220), while in other embodiments it is excluded.

In some embodiments the device is configured to estimate DHI by a combination of measurements from north irradiance sensor (202) with diffuse isolator (220) together with measurements additional sensors (e.g. 202, 204, 206, 208, 210 and optionally a ground-facing irradiance sensor). In some embodiments, the device is configured to use readings of any of the sensors, such as (210) as previously described, to estimate a clearness index or another index which partitions analysis into different cases, and to determine DHI solely from north irradiance sensor (202) in some cases (e.g. when clearness index is high) and to determine DHI from the other irradiance sensors (e.g. 202, 204, 206, 208, 210 and optional ground-facing sensor) in other cases (e.g. when clearness index is low).

In some embodiments the device is configured to determine DI using an analysis model whose inputs include readings of north irradiance sensor (202) with diffuse isolator (220), readings of any combination of additional irradiance sensors (e.g. 202, 204, 206, 208, 210 and/or optional ground-facing sensor), and/or values calculated therefrom. In some embodiments said analysis is implemented as a trained neural network model. In some embodiments said trained neural network model is trained against a reference instrument the produces suitably accurate values of DHI.

In some embodiments wherever “DHI” is stated, another equivalent measure of diffuse (104) irradiance may be used and the device is configured to determine or output said other measure.

In the foregoing, “the device” means a device or system according to the disclosed subject matter.

In some embodiments, a device or system according to the disclosed subject matter computes and/or measures any of a number of irradiance components or metrics which may be derived from the readings of irradiance sensors (202, 204, 206, 208, 210, and optional ground-facing sensor), including: direct irradiance (102), diffuse irradiance (104), ground-reflected irradiance (106), global horizontal irradiance, plane-of-array irradiance, global tilted irradiance on an arbitrary plane, albedo (ratio of horizontal upwelling to horizontal downwelling irradiance), and others.

1. A device comprising
an irradiance sensor, and
a diffuse isolator covering said irradiance sensor,
wherein said diffuse isolator comprises a housing, baffles, aperture openings, and a window, and
wherein said diffuse isolator is configured to block direct rays emanating from the sun, and
wherein said diffuse isolator is configured to admit diffuse rays emanating from a region of the sky dome, and
wherein said device is configured to measure diffuse solar irradiance at least from readings of said irradiance sensor.

2. The device of claim 1, comprising at least one additional irradiance sensor configured to view at least a substantial portion of the sky dome, and wherein said device is configured to measure diffuse solar irradiance at least from readings of said irradiance sensor and said at least one additional irradiance sensor.
